(19) United States
(12) Patent Application Publication
(10) Pub. No.: US 2025/0117651 A1
(43) Pub. Date: Apr. 10, 2025

(54) SYSTEM AND METHOD FOR COMPILING A TRAINED ARTIFICIAL NEURAL NETWORK

(71) Applicant: STMicroelectronics International N. V., Geneva (CH)

(72) Inventors: Pierre Demaj, Nice (FR); Laurent Folliot, Gourdon (FR)

(21) Appl. No.: 18/910,448

(22) Filed: Oct. 9, 2024

(30) Foreign Application Priority Data
Oct. 10, 2023 (FR) 2310810

(51) Int. Cl. G06N 3/08

(52) U.S. Cl. CPC G06N 3/08

(57) ABSTRACT

According to one aspect, a computer-implemented method compiles a first trained artificial neural network comprising at least one succession of layers including a depthwise convolutional layer, a saturated rectified linear unit layer, and a two-dimensional convolutional layer. The method comprises equalizing between layers, replacing the saturated rectified linear unit layer with an adaptive channel pruning layer to obtain an artificial neural network with a modified topology, tensor quantizing the layers of the artificial neural network with the modified topology, and compiling the quantized artificial neural network with the modified topology.

### CROSS REFERENCE TO RELATED APPLICATIONS

This application claims the benefit of French Patent Application No. 2310810, filed on Oct. 10, 2023, which application is hereby incorporated herein by reference.

### TECHNICAL FIELD

Embodiments relate to artificial neural networks.

### BACKGROUND

Artificial neural networks generally comprise a succession of neuron layers. Each layer takes as input data to which weights are applied and delivers as output data after processing by functions for activating the neurons of the layer. These output data (also called “activations”) are transmitted to the following layer in the neural network.

The weights are data, more specifically parameters, of neurons that can be configured to obtain good data at the output of the layers. The weights of a layer are defined in a weight tensor. The weight tensor can have a plurality of channels.

The weights are adjusted during a generally supervised learning phase, in particular by running the neural network with already classified data from a reference database as input data. This learning phase enables a trained neural network to be obtained.

Once they have been trained, the neural networks can be integrated into integrated circuits, such as microcontrollers.

In particular, it is possible to use an integration software in order to integrate an artificial neural network into an integrated circuit. For example, the integration software STM32Cube.AI and its extension X-CUBE-AI developed by STMicroelectronics are known.

Furthermore, certain integrated circuits comprise an artificial neural network processing circuit, also called artificial neural network accelerators. Such a specific circuit is designed to improve the runtime performance of artificial neural networks. Such a circuit can in particular be designed according to a specific hardware architecture to optimize common operations of artificial neural networks, such as matrix multiplications, activation functions and convolution operations. This architecture enables high-efficiency parallel computing, for example. In this way, such a circuit is designed to maximize performance in terms of computing speed and energy efficiency. This significantly speeds up the running of an artificial neural network.

Furthermore, an artificial neural network is generally trained using a floating-point representation for its weights and activations. The use of a floating-point representation generally produces a trained artificial neural network with improved accuracy.

However, artificial neural network processing circuits are generally designed to run integer or fixed point quantized neural networks. Artificial neural network processing circuits are generally not designed to run artificial neural networks using a floating-point representation.

In particular, artificial neural networks can be quantized to speed up their running and reduce memory requirements. Neural network quantization involves defining a format for representing neural network data, such as the weights and the inputs and outputs of each layer of the neural network. Quantization makes it possible in particular to switch from a floating-point representation to a fixed-point number format. The layers of a neural network can be quantized in eight bits or in binary, for example. Quantization of the neural network can be implemented by the integration software.

Quantization can be carried out either during the learning phase or after the learning phase.

The acronym “QAT” (Quantization-Aware Training) can be used to describe quantization during the learning phase. Quantization during the learning phase requires a trained artificial neural network to be retrained by simulating quantization. Such quantization is complex, requires a great deal of computation to carry out the learning phase and may also require hyperparameters to be adjusted. Such quantization also has the drawback of requiring all the training data. Nevertheless, quantization during the learning phase brings the performance of the quantized trained neural network closer to the performance of the trained neural network using a floating-point representation for its weights and activations.

Quantization carried out after the learning phase can be referred to using the acronym “PTQ” (Post-Training Quantization). This quantization is carried out using a trained neural network, and requires little or no data. This quantization also requires minimum adjustment of the hyperparameters of the artificial neural network. This quantization does not require a new learning phase for the artificial neural network at a later date. This makes it possible to quantize an artificial neural network more easily compared to quantization of an artificial neural network during the learning phase.

Furthermore, quantization can either be tensor or channel quantization.

Tensor quantization uses a single set of weight tensor quantization parameters. In other words, the weights of a same tensor share the same scale and a same offset.

Channel quantization uses separate parameter sets for each output channel of the weight tensor. In other words, the weights of a same channel of a weight tensor share the same scale and a same offset but this scale and offset may differ from one channel of the weight tensor to another. Channel quantization improves the granularity of quantization. This generally improves the accuracy of the quantized neural network compared to tensor quantization.

However, channel quantization is complicated to implemented on artificial neural network processing circuits. In particular, channel quantization may require scaling when using data that does not have the same scale. Tensor quantization is thus chosen more often when the artificial neural network is integrated into an integrated circuit, such as a microcontroller, using a neural network processing circuit.

The publication “A White Paper on Neural Network Quantization,” Markus Nagel et al., published on 15 Jun. 2021 on the website arXiv.org, describes a solution for improving the accuracy of a tensor-quantized artificial neural network to bring it close to the accuracy of a trained artificial neural network using a floating-point representation. In particular, the publication describes a quantization method using cross-layer equalization and bias absorption.

However, the solution put forward by this publication proves insufficient in certain cases.

There is therefore a need to improve tensor quantization of artificial neural networks.

### SUMMARY

According to one aspect, a method is proposed, performed by computer, for compiling a first trained artificial neural network, the first trained artificial neural network comprising at least one succession of layers including a depthwise convolutional layer, then a saturated rectified linear unit layer, then a two-dimensional convolutional layer, the method comprising equalization between the depth wise convolutional layer and the two-dimensional convolutional layer, replacing the saturated rectified linear unit layer with an adaptive channel pruning layer so as to obtain an artificial neural network with modified topology, tensor quantization of the layers of the artificial neural network with modified topology, and compiling the quantized artificial neural network with modified topology so as to generate a computer program comprising instructions which, when the program is run by a computer, lead it to implement the quantized artificial neural network with modified topology.

The adaptive channel pruning layer avoids the need to use a saturated rectified linear unit layer, whilst preserving the initial behaviour of the artificial neural network.

The compilation method thus makes it possible to carry out tensor quantization after training the artificial neural network whilst limiting the loss of accuracy of the quantized artificial neural network compared to the trained artificial neural network using a floating-point representation for its weights and its activations.

Such tensor quantization after training the artificial neural network has the advantage of being carried out without requiring all the data used to carry out the training.

Such tensor quantization has the advantage of being implemented easily compared to quantization during the learning phase.

According to one advantageous embodiment, the adaptive channel pruning layer is adapted according to a saturation value defined for the saturated rectified linear unit layer.

The adaptive channel pruning layer is preferably designed to prune each channel of the activation tensor generated by the depthwise convolutional layer between a minimum value equal to 0 and a maximum value calculated by applying the formula:

max_val=X×sᵢ⁻¹, where max_val is the maximum value, X is a saturation value defined by the saturated rectified linear unit layer and

$${s}_{i} = \frac{1}{{r}_{i}^{( 2 )}} \sqrt{{r}_{i}^{( 1 )} {r}_{i}^{( 2 )}} ,$$

where rᵢ⁽¹⁾ corresponds to the range of values of the channel i of a weight tensor of the depthwise convolutional layer and rᵢ⁽²⁾ corresponds to the range of values of the channel i of a weight tensor of the two-dimensional convolutional layer.

In one advantageous embodiment, the method also comprises bias absorption between the depthwise convolutional layer and the two-dimensional convolutional layer.

Advantageously, the method also comprises:
obtaining an initial trained artificial neural network comprising at least one succession of layers including a depthwise convolutional layer, then a first batch normalization layer, then a saturated rectified linear unit layer, then a two-dimensional convolutional layer, then possibly a second batch normalization layer, and fusing the first batch normalization layer of the initial trained artificial neural network with the depthwise convolutional layer, and possibly fusing the second batch normalization layer with the two-dimensional convolutional layer, so as to obtain the first trained artificial neural network.

According to another aspect, a compilation computer program product is proposed comprising instructions which, when the program is run by a computer, lead it to implement a compilation method as described above.

According to another aspect, a quantized and trained artificial neural network is proposed comprising at least one succession of layers including a depthwise convolutional layer, then an adaptive channel pruning layer, then a two-dimensional convolutional layer.

According to another aspect, a computer system is proposed comprising a memory storing a compilation computer program product as described above, and a main processor designed to run the compilation computer program.

According to another aspect, a computer-readable data medium is proposed, on which the compilation computer program product as described above is stored.

According to another aspect, a computer program product is proposed comprising instructions which, when the program is run by a computer, lead it to implement a quantized artificial neural network with modified topology obtained according to a compilation method as described above.

According to another aspect, a microcontroller is proposed comprising a memory storing a computer program product as described above to run a quantized artificial neural network with modified topology, and a main processor designed to run the computer program.

In one advantageous embodiment, the microcontroller also comprises a neural network processing circuit designed to run the quantized artificial neural network with modified topology.

According to another aspect, a computer-readable data medium is proposed, on which the computer program product as described above is stored in order to run a quantized artificial neural network with modified topology.

### BRIEF DESCRIPTION OF DRAWINGS

Other advantages and features of the invention will become apparent upon reading the detailed description of embodiments, which are in no way limiting, and of the appended drawings in which:

FIG. 1 illustrates an embodiment of a computer system;

FIG. 2 illustrates an embodiment of a method for compiling an artificial neural network;

FIG. 3 illustrates a compilation method;

FIG. 4 illustrates an artificial neural network having a succession of layers;

FIG. 5 illustrates an artificial neural network having a succession of layers; and

FIG. 6 illustrates an embodiment microcontroller configured to run a quantized artificial neural network.

### DETAILED DESCRIPTION OF ILLUSTRATIVE EMBODIMENTS

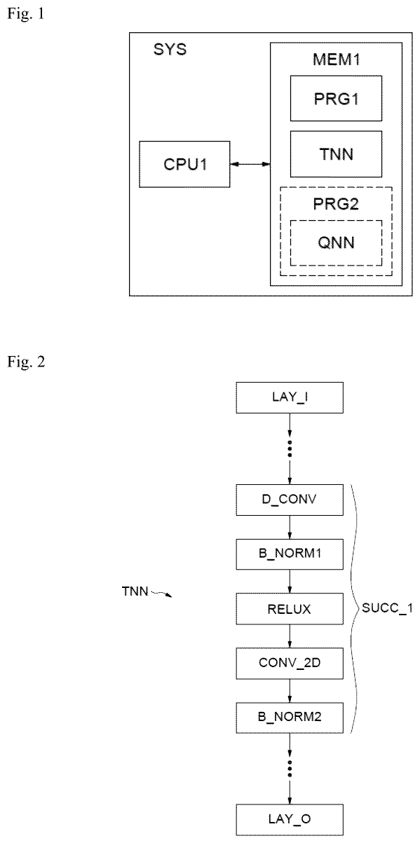

FIG. 1 shows an embodiment of a computer system SYS. The computer system SYS comprises a main processor CPU1 and a memory MEM1. The memory MEM1 stores a compilation computer program PRG1 comprising instructions which, when the program is run by the main processor CPU1, lead it to implement a method for compiling an artificial neural network as described below with reference to FIG. 2.

The compilation computer program PRG1 can be comprised in an integration software. The integration software is designed to integrate a quantized neural network into an integrated circuit.

FIG. 2 shows an embodiment of a method for compiling an artificial neural network. This method can be implemented by running the compilation computer program PRG1.

The method comprises obtaining 10 the trained artificial neural network TNN. The trained artificial neural network TNN can be provided as input to the integration software.

The trained artificial neural network TNN comprises a succession of neuron layers. Each layer takes as input data to which weights are applied and delivers as output data after processing by functions for activating the neurons of the layer. These output data (also referred to as “activations”) are transmitted to the following layer in the neural network. In particular, the trained artificial neural network TNN then comprises an input layer LAY_I designed to receive input data from the artificial neural network TNN and an output layer LAY_O designed to generate output data from the artificial neural network TNN.

The weights of a layer are defined in a weight tensor. The weight tensor can have a plurality of channels. The weights are data, more specifically parameters, of neurons that can be configured to obtain good data at the output of the layers.

The weights are adjusted during a generally supervised learning phase, in particular by running the neural network with already classified data from a reference database as input data. This learning phase enables a trained neural network to be obtained.

The training is intended to define a neural network, the performance of which is optimal. More specifically, during the training of the neural network, the weights of the neural network are adjusted, then the performance of the modified network is evaluated. If the performance of the neural network is satisfactory, the training of the network is terminated.

The trained neural network can use a floating-point representation for the weights and the data (activations) generated by each neural network layer.

The trained neural network has a format known to a person skilled in the art. For example, the trained neural network can be obtained from artificial neural network design software, such as Keras, Tensorflow and ONNX (an acronym for “Open Neural Network Exchange”).

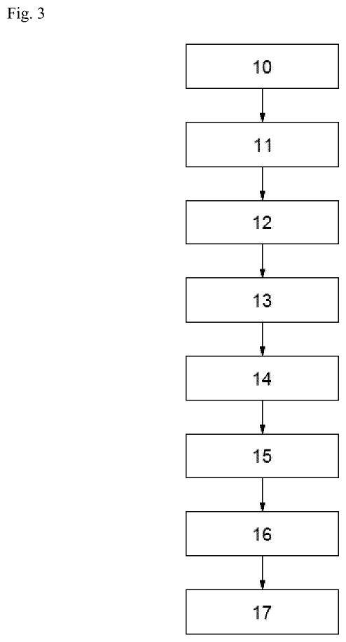

As shown in FIG. 3, the artificial neural network comprises at least one succession SUCC_1 of layers, known as succession of layers of interest, including a depthwise convolutional layer D_CONV, then a first batch normalization layer B_NORM1, then a saturated rectified linear unit layer RELUX, then a two-dimensional convolutional layer CONV_2D then possibly a second batch normalization layer B_NORM2. In FIG. 3, only one succession SUCC_1 of layers of interest is shown. However, the artificial neural network can comprise a plurality of successions of layers of interest as shown in FIG. 3.

The depthwise convolutional layer D_CONV is designed to apply a convolutional kernel to each input channel of the depthwise convolutional layer. A convolutional kernel is therefore defined for each input channel of the depthwise convolutional layer.

The first batch normalization layer B_NORM1 is designed to normalize the tensor activations that it receives as input. In particular, the batch normalization layer is designed to calculate an average and a standard deviation of the activations, and then to normalize the activations by subtracting them from the calculated average and dividing them by the calculated standard deviation. The first batch normalization layer is used to reduce drift effects of a distribution of activations during the learning phase of the artificial neural network. The first batch normalization layer is also used to speed up convergence during training. Such faster convergence means that the artificial neural network can be trained faster. This also helps to reduce the phenomenon of over-fitting. Overfitting corresponds to an adjustment of the artificial neural network during training that is too closely linked to the training data (e.g. training images). Such overfitting can lead to a reduction in accuracy of the artificial neural network when it is run with input data that are different from the training data (for example new images). In other words, overfitting means that an artificial neural network loses its ability to generalize to data that are different from those used for training.

The saturated rectified linear unit layer RELUX helps introduce non-linearity into the artificial neural network. Such non-linearity enables the artificial neural network to learn complex functions.

In particular, the saturated rectified linear unit layer is designed to perform the following function:

ReLUX(z)=min(max(0, z), X), where z corresponds to an output of the first batch normalization layer on the channel i, ReLUX(z) corresponds to an activation of the output tensor of the first batch normalization layer on the channel i, and X corresponds to the saturation value.

In other words, the saturated rectified linear unit layer RELUX is used to generate an output tensor in which the values of the activations of each channel of the output tensor correspond to the minimum value between the defined saturation value X and the maximum value between 0 and the corresponding value of the activations of the associated channel of the input tensor.

For example, the saturated rectified linear unit layer at 6 (“ReLU6”) is designed to perform the following function:

ReLU6(z)=min(max(0, z), 6), where z corresponds to an output of the first batch normalization layer on the channel i, ReLU6(z) corresponds to an activation of the output tensor of the first batch normalization layer on the channel i, and 6 corresponds to the saturation value.

The two-dimensional convolutional layer CONV_2D is designed to apply a same convolutional kernel to all the channels of the activation tensor that this two-dimensional convolutional layer receives as input.

Similarly to the first batch normalization layer B_NORM1, the second batch normalization layer B_NORM2 is designed to normalize the tensor activations that is receives as input. In particular, the batch normalization layer is designed to calculate an average and a standard deviation of the activations, and then to normalize the activations by subtracting them from the calculated average and dividing them by the calculated standard deviation. The second batch normalization layer is used to reduce drift effects of a distribution of activations during the learning phase of the artificial neural network. The second batch normalization layer is also used to speed up convergence during training. Such faster convergence means that the artificial neural network can be trained faster. This also reduces the phenomenon of overfitting.

The compilation method comprises detecting 11 the at least one succession SUCC_1 of layers of interest. In this step, the main processor CPU1 detects each succession SUCC_1 of layers of interest, which therefore comprises a depthwise convolutional layer D_CONV, then a first batch normalization layer B_NORM1, then a saturated rectified linear unit RELUX, then a two-dimensional convolutional layer CONV_2D then possibly a second batch normalization layer B_NORM2. This detection is carried out based on information associated with each layer of the trained artificial neural network.

The main processor CPU1 then carries out steps 12 to 15 described below for each succession SUCC_1 of layers of interest detected.

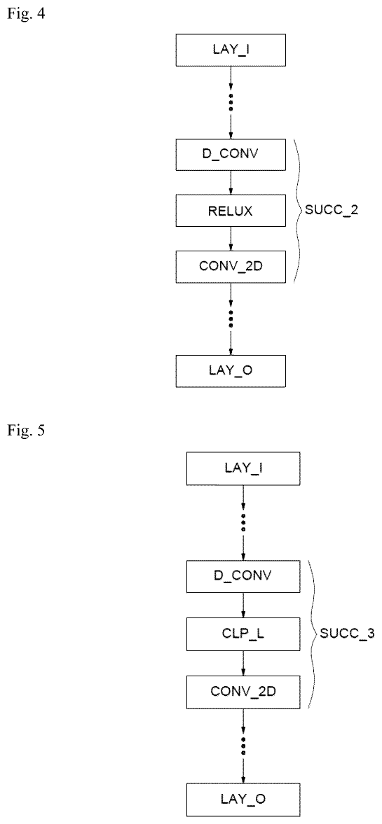

In particular, the method comprises a step 12 for fusing the batch normalization layers B_NORM1, B_NORM2 with the layers D_CONV, CONV_2D which precede them. This step 12 is carried out by the main processor CPU1. This fusion can be referred to as “batch normalization folding”. The fusion removes the operations of each batch normalization layer in the artificial neural network, so as to obtain a succession SUCC_2 of layers, as shown in FIG. 4. In particular, the operations of each batch normalization layer are integrated into the layer that precedes this batch normalization layer. This reduces the number of calculations required to perform each batch normalization layer.

In particular, the weights and biases associated with the layer that precedes each batch normalization layer are recalculated so as to integrate the operations of the batch normalization layer. In particular, the weights of the layer that precedes the batch normalization layer are calculated using the following function:

$${\tilde{W}}_{k} = \frac{{γ}_{k} {W}_{k}}{\sqrt{{σ}_{k}^{2} + ε}} ,$$

where γₖ is a hyperparameter, the value of which is defined by training, Wₖ is the value of the former weight, σ is the variance calculated during training and ε is a predefined constant.

The biases of the layer that precedes the batch normalization layer are calculated using the following function:

$$= \frac{{γ}_{k}}{\sqrt{{σ}_{k}^{2} + ε}} ( {b}_{k} - {μ}_{k} ) + {β}_{k} ,$$

where bₖ is the initial value of the bias, βₖ is a first hyperparameter of the batch normalization layer, the value of which is defined by training, γₖ is a second parameter of the batch normalization layer, μₖ is the average calculated during training, σₖ is the variance calculated during training and ε is a predefined constant.

The method then comprises a step 13 of cross-layer equalization. This step 13 of equalization is carried out by the main processor CPU1. The step 13 of cross-layer equalization corresponds to the method described in the publication “A White Paper on Neural Network Quantization”, Markus Nagel et al, 15 Jun. 2021.

The cross-layer equalization is designed to adapt the weights and biases of two consecutive layers of an artificial neural network, for example between the depthwise convolutional layer D_CONV and the two-dimensional convolutional layer CONV_2D, separated by the saturated rectified linear unit layer RELUX.

In particular, for two consecutive layers of the artificial neural network, the output activation tensor of the first layer can be defined by the expression.

h=f(W⁽¹⁾x+b⁽¹⁾), where f is the activation function of the first layer, W⁽¹⁾ is the initial weight tensor of the first layer, x corresponds to the activation tensor as the input to the first layer and b⁽¹⁾ is the bias tensor of the first layer.

The output activation tensor of the second layer can be defined by the expression.

y=f(W⁽²⁾h+b⁽²⁾), where f is the activation function of the second layer, W⁽²⁾ is the initial weight tensor of the second layer, h corresponds to the activation tensor as the input to the second layer and b⁽²⁾ is the bias tensor of the second layer.

By applying cross-layer equalization, it is possible to redefine the weight tensors of the two successive layers such that y=f(\tilde{W}⁽²⁾\hat{f}(\tilde{W}⁽¹⁾x+\tilde{b}⁽¹⁾)+b⁽²⁾), where \tilde{W}⁽²⁾=W⁽²⁾ S corresponds to the new weight tensor of the second layer, \tilde{W}⁽¹⁾=S⁻¹W⁽¹⁾ corresponds to the new weight tensor of the first layer, \tilde{b}⁽¹⁾=S⁻¹b⁽¹⁾corresponds to the new bias tensor of the first layer, \hat{f} corresponds to the adaptive pruning function described below, and where S=diag(s) is a diagonal matrix, the values Sᵢᵢ of which correspond to the scale factor sᵢ.

In particular, the scale factor sᵢ is defined to equalize the ranges of values between different successive layers. More specifically, the scale factor sᵢ is obtained by the formula:

$${s}_{i} = \frac{1}{{r}_{i}^{( 2 )}} \sqrt{{r}_{i}^{( 1 )} {r}_{i}^{( 2 )}} ,$$

where rᵢ⁽¹⁾ corresponds to the range of values of the channel i of a weight tensor of the depthwise convolutional layer and rᵢ⁽²⁾ corresponds to the range of values of the channel i of a weight tensor of the two-dimensional convolutional layer.

Such a scale factor makes it possible to improve the robustness of quantization by reducing quantization noise.

Cross-layer equalization helps avoid the problem of magnitude difference between the elements of a same tensor. This problem often occurs in particular when a depthwise convolutional layer is used. Cross-layer equalization thus helps reduce a loss of accuracy that may result from tensor quantization.

The method then comprises a step 14 of bias absorption. This step 14 of bias absorption is carried out by the main processor CPU1. This step 14 of bias absorption corresponds to the method described in the publication “A White Paper on Neural Network Quantization”, Markus Nagel et al, 15 Jun. 2021.

Bias absorption is designed to modify the parameters in order to absorb the biases, using the following formula:

$$y = {W}^{( 2 )} \tilde{h} + {\tilde{b}}^{( 2 )} , where {\tilde{b}}^{( 2 )} = {W}^{( 2 )} {c}_{i} + {b}^{( 2 )} , \tilde{h} = h - {c}_{i} , {\tilde{b}}^{( 1 )} = {b}^{( 1 )} - {c}_{i}$$

where cᵢ=max(0,βᵢ−3γᵢ), βᵢ and γᵢ being two hyperparameters of the batch normalization layer BNORM1 for the channel i. The value ‘3’ can also be adjusted using simulation by extracting activation statistics.

Furthermore, if the saturated rectified linear unit layer frequently leads to saturation, cross-layer equalization may be insufficient to avoid a loss of accuracy resulting from tensor quantization.

To address this problem, the method then comprises a step 15 for replacing the saturated rectified linear unit layer. This step 15 is carried out by the main processor CPU1. In this step, the saturated rectified linear unit layer is replaced by an adaptive channel pruning layer CPL_L, so as to obtain a succession SUCC_3 of layers, as shown in FIG. 5. This step therefore leads to a modification of the topology of the artificial neural network.

The adaptive channel pruning layer CPL_L is designed to prune the output tensor of the depthwise convolutional layer.

In particular, each channel of the tensor generated by the depthwise convolutional layer is pruned independently between a minimum value and a maximum value. The minimum value is defined at 0. The maximum value is calculated in accordance with the following formula: max_val=X×sᵢ⁻¹, where max_val is the maximum value, X is the saturation value defined by the replaced saturated rectified linear unit layer and sᵢ is the value calculated for cross-layer equalization for the channel i.

The adaptive channel pruning layer avoids the need to use a saturated rectified linear unit layer, whilst preserving the initial behaviour of the artificial neural network.

The method then comprises a step 16 of tensor quantization of the layers of the artificial neural network. This step 16 is carried out by the main processor CPU1.

In this way, such a method makes it possible to obtain a quantized and trained artificial neural network QNN having a level of accuracy close to that of the trained artificial neural network using a floating point representation for its weights and its activations.

The method then comprises a step 17 for compiling the quantized and trained artificial neural network QNN. This step 17 is carried out by the main processor CPU1. This step 17 makes it possible to generate a computer program PRG2 comprising instructions which, when the program is run by a computer, lead it to implement the obtained quantized artificial neural network QNN. In particular, the computer program QNN can comprise instructions so that the quantized artificial neural network can be run by an artificial neural network processing circuit. This computer program PRG2 is therefore stored in the memory MEM1 of the computer system SYS.

This computer program PRG2 can then be integrated into an integrated circuit, such as a microcontroller MCU. The integrated circuit can then implement the quantized artificial neural network QNN by performing the instructions of the computer program PRG2.

The aforementioned compilation method makes it possible to carry out tensor quantization after training the artificial neural network whilst limiting the loss of accuracy of the quantized artificial neural network compared to the trained artificial neural network using a floating-point representation for its weights and its activations.

Such tensor quantization after training the artificial neural network has the advantage of being carried out without requiring all the data used to carry out the training. A limited amount of the data used for training may still be required to calibrate layer outputs and activations.

Such tensor quantization has the advantage of being implemented easily compared to quantization during training.

Moreover, the modified topology of the artificial neural network has minimum impact on the runtime of the artificial neural network and on the amount of data that has to be stored in a flash memory of the integrated circuit integrating the artificial neural network.

Of course, the embodiment of the aforementioned compilation method is open to various variants and modifications which will become apparent to those skilled in the art. In particular, the processor can perform steps 13 to 15 only for certain successions of layers of interest. In particular, the computer program PRG1 can be designed to determine which successions of layers of interest are likely to comprise a saturated rectified linear unit layer, the saturation frequency of which during running of the trained neural network is greater than a predefined threshold. More specifically, the saturation can be evaluated by running the trained artificial neural network using input data already used during the learning phase of the artificial neural network. The computer program PRG1 can then be designed to carry out steps 13 to 15 only for the successions SUCC_1 of layers of interest likely to comprise a saturated rectified linear unit layer, the saturation frequency of which during running of the trained neural network is greater than a predefined threshold. The computer program PRG1 can also be designed to modify the saturated rectified linear unit layer of the other successions SUCC_1 of layers of interest by a non-saturation rectified linear unit layer (i.e. “ReLU” type).

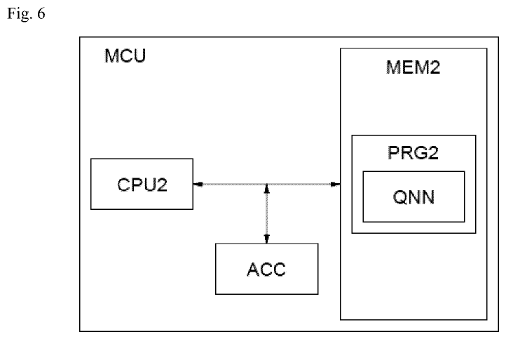

FIG. 6 shows an embodiment of a microcontroller MCU designed to run a quantized artificial neural network QNN obtained by the method described above with reference to FIG. 3.

The microcontroller comprises a main processor CPU2, a memory MEM2, and an artificial neural network processing circuit ACC. The memory MEM2 stores a computer program PRG2 comprising instructions which, when the program is run by the neural network processing circuit ACC, lead it to implement the quantized artificial neural network QNN.

1. A computer-implemented method for compiling a first trained artificial neural network comprising at least one succession of layers including a depthwise convolutional layer, then a saturated rectified linear unit layer, and then a two-dimensional convolutional layer, the method comprising:
equalizing, with a processor, between the depthwise convolutional layer and the two-dimensional convolutional layer;
replacing, with the processor, the saturated rectified linear unit layer with an adaptive channel pruning layer to obtain an artificial neural network with a modified topology;
tensor quantizing, with the processor, the layers of the artificial neural network with the modified topology to obtain a quantized artificial neural network with the modified topology; and
compiling, with the processor, the quantized artificial neural network with the modified topology to generate a computer program comprising instructions that, when the computer program is run by a computer, cause the computer to implement the quantized artificial neural network with the modified topology.

2. The method according to claim 1, wherein the adaptive channel pruning layer is adapted according to a saturation value defined for the saturated rectified linear unit layer.

3. The method according to claim 2, wherein the adaptive channel pruning layer is configured to prune each channel of an activation tensor generated by the depthwise convolutional layer between a minimum value equal to o and a maximum value calculated by applying the formula:
$$max\_val = X \times {s}_{i}^{- 1}$$
where max_val is the maximum value, X is the saturation value defined by the saturated rectified linear unit layer and
$${s}_{i} = \frac{1}{{r}_{i}^{( 2 )}} \sqrt{{r}_{i}^{( 1 )} {r}_{i}^{( 2 )}} ,$$
where rᵢ⁽¹⁾ corresponds to a first range of values of a channel i of a first weight tensor of the depthwise convolutional layer and rᵢ⁽²⁾ corresponds to a second range of values of the channel i of a second weight tensor of the two-dimensional convolutional layer.

4. The method according to claim 1, further comprising bias absorbing between the depthwise convolutional layer and the two-dimensional convolutional layer.

5. The method according to claim 1, further comprising:
obtaining an initial trained artificial neural network comprising at least one initial succession of layers including an initial depthwise convolutional layer, then a first batch normalization layer, then an initial saturated rectified linear unit layer, and then an initial two-dimensional convolutional layer; and
fusing the first batch normalization layer of the initial trained artificial neural network with the initial depthwise convolutional layer to obtain the first trained artificial neural network.

6. The method according to claim 5, wherein the at least one initial succession of layers further includes a second batch normalization layer after the initial two-dimensional convolutional layer, and the method further comprises:
fusing the second batch normalization layer with the initial two-dimensional convolutional layer to obtain the first trained artificial neural network.

7. A non-transitory computer-readable medium storing computer instructions for compiling a first trained artificial neural network comprising at least one succession of layers including a depthwise convolutional layer, then a saturated rectified linear unit layer, and then a two-dimensional convolutional layer, that, when the computer instructions are run by a processor, cause the processor to perform the steps of:
equalizing between the depthwise convolutional layer and the two-dimensional convolutional layer;
replacing the saturated rectified linear unit layer with an adaptive channel pruning layer to obtain an artificial neural network with a modified topology;
tensor quantizing the layers of the artificial neural network with the modified topology to obtain a quantized artificial neural network with the modified topology; and
compiling the quantized artificial neural network with the modified topology to generate a computer program comprising compiled instructions that, when the computer program is run by a computer, cause the computer to implement the quantized artificial neural network with the modified topology.

8. The non-transitory computer-readable medium according to claim 7, wherein the adaptive channel pruning layer is adapted according to a saturation value defined for the saturated rectified linear unit layer.

9. The non-transitory computer-readable medium according to claim 8, wherein the adaptive channel pruning layer is configured to prune each channel of an activation tensor generated by the depthwise convolutional layer between a minimum value equal to o and a maximum value calculated by applying the formula:
$$max\_val = X \times {s}_{i}^{- 1}$$
where max_val is the maximum value, X is the saturation value defined by the saturated rectified linear unit layer and
$${s}_{i} = \frac{1}{{r}_{i}^{( 2 )}} \sqrt{{r}_{i}^{( 1 )} {r}_{i}^{( 2 )}} ,$$
where rᵢ⁽¹⁾ corresponds to a first range of values of a channel i of a first weight tensor of the depthwise convolutional layer and rᵢ⁽²⁾ corresponds to a second range of values of the channel i of a second weight tensor of the two-dimensional convolutional layer.

10. The non-transitory computer-readable medium according to claim 7, comprising further computer instructions, that, when run by the processor, cause the processor to perform the step of bias absorbing between the depthwise convolutional layer and the two-dimensional convolutional layer.

11. The non-transitory computer-readable medium according to claim 7, comprising further computer instructions, that, when run by the processor, cause the processor to perform the steps of:
obtaining an initial trained artificial neural network comprising at least one initial succession of layers including an initial depthwise convolutional layer, then a first batch normalization layer, then an initial saturated rectified linear unit layer, and then an initial two-dimensional convolutional layer; and
fusing the first batch normalization layer of the initial trained artificial neural network with the initial depthwise convolutional layer to obtain the first trained artificial neural network.

12. The non-transitory computer-readable medium according to claim 11, wherein the at least one initial succession of layers further includes a second batch normalization layer after the initial two-dimensional convolutional layer, and the non-transitory computer-readable medium comprises further computer instructions, that, when run by the processor, cause the processor to perform the step of:
fusing the second batch normalization layer with the initial two-dimensional convolutional layer to obtain the first trained artificial neural network.

13. A computer system for compiling a first trained artificial neural network comprising at least one succession of layers including a depthwise convolutional layer, then a saturated rectified linear unit layer, and then a two-dimensional convolutional layer, the computer system comprising:
a non-transitory memory storage comprising computer instructions; and
a processor in communication with the non-transitory memory storage, wherein the processor executes the computer instructions to:
equalize between the depthwise convolutional layer and the two-dimensional convolutional layer;
replace the saturated rectified linear unit layer with an adaptive channel pruning layer to obtain an artificial neural network with a modified topology;
tensor quantize the layers of the artificial neural network with the modified topology to obtain a quantized artificial neural network with the modified topology; and
compile the quantized artificial neural network with the modified topology to generate a computer program comprising compiled instructions that, when the computer program is run by a computer, cause the computer to implement the quantized artificial neural network with the modified topology.

14. The computer system according to claim 13, wherein the adaptive channel pruning layer is adapted according to a saturation value defined for the saturated rectified linear unit layer.

15. The computer system according to claim 14, wherein the adaptive channel pruning layer is configured to prune each channel of an activation tensor generated by the depthwise convolutional layer between a minimum value equal to 0 and a maximum value calculated by applying the formula:
$$max\_val = X \times {s}_{i}^{- 1}$$
where max_val is the maximum value, X is the saturation value defined by the saturated rectified linear unit layer and
$${s}_{i} = \frac{1}{{r}_{i}^{( 2 )}} \sqrt{{r}_{i}^{( 1 )} {r}_{i}^{( 2 )}} ,$$
where rᵢ⁽¹⁾ corresponds to a first range of values of a channel i of a first weight tensor of the depthwise convolutional layer and rᵢ⁽²⁾ corresponds to a second range of values of the channel i of a second weight tensor of the two-dimensional convolutional layer.

16. The computer system according to claim 13, wherein the processor executes further computer instructions to bias absorb between the depthwise convolutional layer and the two-dimensional convolutional layer.

17. The computer system according to claim 13, wherein the processor executes the computer instructions to:
obtain an initial trained artificial neural network comprising at least one initial succession of layers including an initial depthwise convolutional layer, then a first batch normalization layer, then an initial saturated rectified linear unit layer, and then an initial two-dimensional convolutional layer; and
fuse the first batch normalization layer of the initial trained artificial neural network with the initial depthwise convolutional layer to obtain the first trained artificial neural network.

18. The computer system according to claim 17, wherein the at least one initial succession of layers further includes a second batch normalization layer after the initial two-dimensional convolutional layer, and the processor executes further computer instructions to:
fuse the second batch normalization layer with the initial two-dimensional convolutional layer to obtain the first trained artificial neural network.

19. A microcontroller comprising:
a non-transitory memory storage comprising compiled instructions; and
a processor in communication with the non-transitory memory storage, wherein the compiled instructions comprise a quantized artificial neural network with a modified topology generated from a first trained artificial neural network comprising at least one succession of layers including a depthwise convolutional layer, then a saturated rectified linear unit layer, and then a two-dimensional convolutional layer, the quantized artificial neural network with the modified topology generated by:
equalizing between the depthwise convolutional layer and the two-dimensional convolutional layer;
replacing the saturated rectified linear unit layer with an adaptive channel pruning layer to obtain a first artificial neural network with the modified topology;
tensor quantizing the layers of the artificial neural network with the modified topology to obtain the quantized artificial neural network with the modified topology; and
compiling the quantized artificial neural network with the modified topology to generate the compiled instructions that, when run by the microcontroller, cause the microcontroller to implement the quantized artificial neural network with the modified topology.

20. The microcontroller according to claim 19, further comprising a neural network processing circuit configured to run the quantized artificial neural network with the modified topology.
